(19) United States
(12) Patent Application Publication
(10) Pub. No.: US 2003/0081415 A1
(43) Pub. Date: May 1, 2003

(54) Arrangement of lamp fixture for string of lamp

(76) Inventor: Jocelyn Yu, Taipei (TW)

Correspondence Address: BACON & THOMAS, 4th Floor, 625 Slaters Lane, Alexandria, VA, 22314, US

(21) Appl. No.: 10/230,099

(22) Filed: Aug. 29, 2002

(30) Foreign Application Priority Data
Oct. 29, 2001 (CN) 01266216.X

(51) Int. Cl. F21V 1/00; F21L 4/00

(52) U.S. Cl. 362/235; 362/186; 362/800

(57) ABSTRACT

A lamp fixture for a string of lamps includes a cylindrical seat; a transparent dome-shaped cover mounted to the cylindrical seat to form a substantially close space; a printed circuit board received in the cylindrical seat; and one or more bulbs connected to the printed circuit board and in the dome-shape cover.

### FIELD OF THE INVENTION

The present invention is related to a string of lamps, and in particular to an arrangement of lamp fixture for a string of lamps, in which a small bulb is mounted.

### BACKGROUND OF THE INVENTION

The conventional string of lamps contains a series of small bulbs which are vulnerable. In order to replace the small bulb with a small lamp fixture, the lamp fixture must be relative small in size and firm, and can be connected to the string of lamps easily. So far there is no such lamp fixture for the string of lamps. Therefore, it is desired to develop a lamp fixture for the string of lamps, which is relative small in size, can be easily connected with high reliability.

The lighting of the small bulbs of the conventional string of lamps cannot be controlled independently. Therefore, it is also desired to develop a lamp fixture for the string of lamps, which contains a circuit for controlling the lighting of a bulb or bulbs mounted therein.

### SUMMARY OF THE INVENTION

It is thus an object of the present invention to provide a lamp fixture for a string of lamps, which has a simple structure, so that it can be conveniently assembled with a high reliability and easy maintenance,

In order to accomplish the aforesaid object, an arrangement of lamp fixture for a string of lamps constructed according to the present invention comprises a cylindrical seat; a transparent dome-shaped cover mounted to the cylindrical seat to form a substantially close space; a printed circuit board received in the cylindrical seat; and one or more bulbs connected to the printed circuit board and in the dome-shape cover.

Preferably, the cylindrical seat has an opening at one end, to which the dome-shaped cover is mounted; and a hole at another end, through which a wire is connected to the printed circuit board.

Preferably, three bulbs are connected to the printed circuit board.

Preferably, the dome-shaped cover is detachably mounted to the opening of the cylindrical seat.

### BRIEF DESCRIPTION OF THE DRAWING

FIG. 1 is a schematic cross sectional view of a preferred embodiment of the present invention.

### DETAILED DESCRIPTION OF THE PREFERRED EMBODIMENT

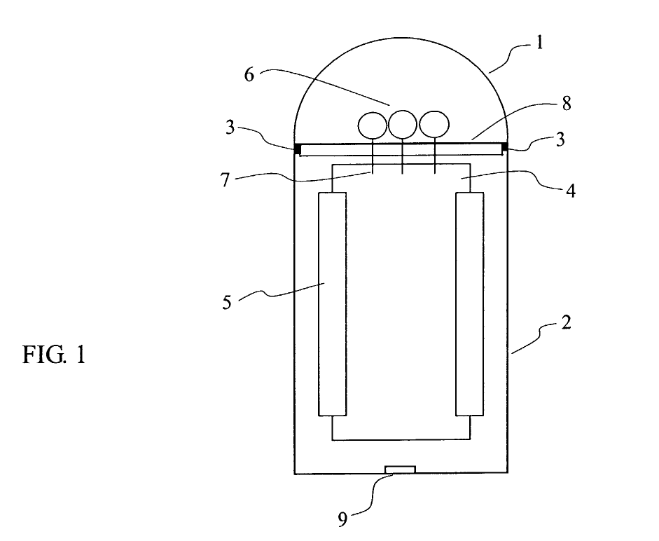

A lamp fixture for a string of lamps constructed according to one of the preferred embodiments is shown in FIG. 1, which contains a dome-shaped upper cover 1; a cylindrical seat 2; a printed circuit board 4; and three LED bulbs 6. The cylindrical seat 2 has an opening 8 at a top thereof, a hole 9 at a bottom thereof, and a pair of slots 5 on its inner wall. The printed circuit board 4 is received in the cylindrical seat 2 by the pair of slots 5 through the opening 8, in which a wire (not shown in the drawing) connected to the printed circuit board 4 passes through the hole 9. The LED bulbs 6 have leads 7, and the leads 7 are connected to the top end of the printed circuit board 4, so that the lighting of the LED bulbs 6 are controlled by the printed circuit board 4. The dome-shaped upper cover 1 is transparent, and is detachably mounted to the opening 10 of the cylindrical seat 2 with the help from protruded detents 3 formed on the inner wall and near the opening 8 of the cylindrical seat 2. As shown in FIG. 1, the LED bulbs 6 and the printed circuit board 4 are protected by the dome-shaped upper cover 1 and the cylindrical seat 2, and, if necessary, the LED bulbs 6 can be replaced readily, when the dome-shaped upper cover 1 is detached from the cylindrical seat 2.

What is claimed is:

1. A lamp fixture for a string of lamps comprising a cylindrical seat; a transparent dome-shaped cover mounted to said cylindrical seat to form a substantially close space; a printed circuit board received in said cylindrical seat; and one or more bulbs connected to said printed circuit board and in said dome-shape cover.

2. The lamp fixture according to claim 1, wherein said cylindrical seat has an opening at one end, to which said dome-shaped cover is mounted; and a hole at another end, through which a wire is connected to said printed circuit board.

3. The lamp fixture according to claim 1, wherein said one or more bulbs are three LED bulbs.

4. The lamp fixture according to claim 1, wherein said dome-shaped cover is detachably mounted to the opening of the cylindrical seat.
